(19) United States
(12) Patent Application Publication
(10) Pub. No.: US 2005/0251474 A1
(43) Pub. Date: Nov. 10, 2005

(54) Method of financing home ownership for sub prime prospective home buyers

(76) Inventors: Michael Shinn, Love Tree, CO (US); John Probst, Highlands Ranch, CO (US); Jeff Richardson, Broomfield, CO (US); Jennifer Richardson, Broomfield, CO (US); Daniel K. Siedlecki, Littleton, CO (US)

Correspondence Address: SHERIDAN ROSS PC, 1560 BROADWAY, SUITE 1200, DENVER, CO, 80202, US

(21) Appl. No.: 11/026,627

(22) Filed: Dec. 30, 2004

Related U.S. Application Data
(60) Provisional application No. 60/533,621, filed on Dec. 31, 2003.

(51) Int. Cl. G06F 17/60

(52) U.S. Cl. 705/39

(57) ABSTRACT

A program for purchasing homes is disclosed. The program is primarily intended for individuals with a poor or sub prime credit rating that precludes them from qualifying for conventional home loan financing. The individuals improve their credit rating as part of the program. The program is preferably operated as a franchise in which franchisees initially purchase homes on behalf of the individuals, lease the homes to the individuals according to a contract entered prior to purchasing the home and, upon successful fulfillment of the lease, the home is sold to the individual using conventional financing. The fulfillment of the lease-to-own contract assists in improving the individual's credit rating and assists in positioning the individual to qualify for conventional home loan financing.

### CROSS-REFERENCE TO RELATED APPLICATION

Priority is claimed from U.S. Provisional Patent Application Ser. No. 60/533,621 filed Dec. 31, 2003, which is incorporated by reference herein in its entirety.

### FIELD OF THE INVENTION

The present application relates to a system and method for financing residential home ownership. More specifically, the system and method are directed primarily to sub prime purchasers who do not readily qualify for conventional modes of home purchase financing but, with the lease to own based system of the present invention, together with the support services provided by other involved entities according to the present invention, can attain not only home ownership, but can acquire a home of their choosing from a larger selection of homes than would otherwise be available to them.

### BACKGROUND OF THE INVENTION

There is a major void in the real estate marketplace. Conservative estimates indicate that approximately 36 million American families currently do not own a home because they do not qualify for conventional financing. For one reason or another, these 36 million families have a bad credit rating, or no credit rating, or some other issue that does not permit them to qualify for financing using one of the existing financing models. Besides poor credit ratings, these reasons include, but are not limited to, insufficient funds for a down payment, self-employment, marital status issues, i.e., divorced or separated, non-permanent resident alien status, non-traditional households, corporate relocation candidates and contingency sales.

According to statistics available from the year 2000, approximately six million working American families spend more than half of their income on housing costs, home price increases exceeded inflation in each of the prior six years, and rent price increases exceeded inflation in each of the prior three years. In addition, home ownership for families of African-American and Hispanic background lagged home ownership for families in general, across the United States, by approximately twenty percent (20%).

Until now, the home buying industry has offered only five ways to buy a home: 1) cash; 2) conventional loans; 3) Federal Housing Administration (FHA)-financed loans; 4) Veterans Administration (VA)-financed loans; and 5) owner-will-carry financing (OWC). However, the above-identified segment of potential homeowners has been under served or completely ignored within the conventional housing and lending industries. The lack of viable alternative solutions are not only a barrier to this segment of potential purchasers, but sustains perceptions that have been perpetrated by lending institutions, home builders and real estate industries as to the unworthiness of this segment. This is compounded by the complicated approval and documentation process utilized by traditional lenders and underwriters. This population segment is also susceptible to predatory lending institutions and practices as many people within this group are inexperienced in financial lending matters, undereducated or do not speak English as their native language.

One option of OWC financing is a lease-to-purchase opportunity. In general terms, the home owner and prospective purchaser enter into a contract by which the prospective purchaser rents the home from the home owner for a period of time, with a portion of the rent applied to the purchase price of the home. At some point, after an agreed amount of money has been paid, the prospective purchaser obtains conventional financing or the homeowner acts as the mortgagor for the property, and title is transferred to the prospective purchaser. However, such options are few and far between and are certainly not available in connection with the vast majority of homes for sale across the United States at any given time. Indeed, most homeowners do not have the financial capability to carry financing for purposes of selling their home. Rather, most homeowners typically require the proceeds from the sale of their own home in order to purchase their next home. Thus, such options are virtually non-existent to this large segment of potential homeowners.

### SUMMARY OF THE INVENTION

In the preferred embodiment, the present invention relates to a system or program (the “Program”) that assists prospective home buyers who have a poor or sub prime credit rating to purchase a home of their own selection. The preferred embodiment of the Program is based upon a franchise model. Besides the prospective home buyer or applicant, participants include a franchisor, a plurality of franchisees, credit counselors, lenders, underwriters, real estate agents, home builders, mortgage and real estate insurance companies, and other entities typically associated with a conventional home purchase.

In simplest terms, a franchise is a license from a trademark or trade name owner permitting another to sell a product or service under that trademark or trade name. The term “franchise” has evolved to include an elaborate agreement under which a franchisee undertakes to conduct a business or sell products or services in accordance with methods and procedures prescribed by a franchisor, and the franchisor undertakes to assist the franchisees through advertising, promotion, advisory services and, perhaps, other services such as discounted pricing on goods or services due to volume purchasing. Thus, in the preferred embodiment, the franchiser coordinates and supports the Program on a nationwide and, perhaps, worldwide basis. The franchiser establishes procedures to be followed and adhered to by the franchisees. The franchisees are dispersed throughout the geographic region involved and interface with the prospective home buyers. Prospective home buyers come to rely on the uniform procedures as implemented by the franchiser and franchisees. In turn, this creates value for the franchisees, including name recognition. Nonetheless, while the preferred embodiment is organized as a franchise operation, other structures or alternatives are available. For example, the Program could also be implemented with a number of master franchisees that have exclusivity over a specific geographic region. These master franchisees would also have the authority to grant individual sub-franchises within their respective territories and may provide the services of the franchisor, as identified herein, to their sub-franchisees. There may also be development areas within each master franchise area. A development area is a smaller geographic area in which one entity has exclusivity to locate and develop franchisees. As another alternative, the Program may be implemented as a simple licensing operation with a single licensor granting non-exclusive or geographically-based exclusive licenses to licensees under certain trademarks or trade names, together with restrictions or requirements placed upon the licensees in exchange for the rights granted under the licenses. The present invention is not and should not be limited to a franchise operation according to the legal definition of the term “franchise.” Rather, it should include within its scope the broader context of a license relationship between at least one licensor and one or more licensees. Moreover, for simplicity purposes, the terms “franchisor” and “franchisee” will be used herein to broadly include a coordinating or overseeing licensor and localized entities or licensees who work directly with prospective home buyers, respectively.

The Program of the present invention is primarily designed to assist persons who do not qualify for conventional loan financing. These persons are typically shut out of home ownership. In addition, the Program provides the prospective home buyer having a poor credit rating with a much greater selection of homes by making all homes available for sale at any given time potentially available to the prospective home buyer, with certain limitations discussed in greater detail below.

In one embodiment, an assessment is made of the prospective home buyer's credit rating and a credit repair plan is devised to improve the prospective home buyer's credit rating within a predetermined time frame. The time frame is preferably 12 to 18 months. If the credit rating of the prospective home buyer or applicant can be improved within the predetermined time frame, such that the applicant will qualify for conventional loan financing at the end of that time frame, a maximum loan amount is determined for the applicant based upon successful completion of the credit repair plan.

With a credit repair plan in place and a maximum loan value determined, the applicant/prospective home buyer may choose to enter into a lease-to-own contract with a franchisee. The franchisee will purchase a home selected by the applicant/prospective home buyer that falls within the applicant's maximum loan amount. The franchisee and applicant will also enter into a lease-to-own contract wherein the franchisee will lease the selected home to the applicant for a predetermined period of time and according to predetermined terms. At the end of the lease period, if the applicant has successfully satisfied the terms of the contract, he or she may exercise their option and purchase the selected home from the franchisee.

One feature of the present Program is that successful fulfillment of the terms of the lease assist in improving the applicant's credit rating and their qualification for conventional financing. The terms of the lease-to-own contract with the franchisee provides that the applicant receive credit for a percentage of the lease payments, which credit will be applied to the purchase price of the home upon the applicant exercising its option to purchase the home. Thus, the Program can assist an applicant to save money for purposes of accumulating a down payment sufficient to satisfy a conventional lender. Also, the successful fulfillment of the lease itself, including timely payment of the monthly lease payments, can positively effect and improve an applicant's credit rating. In other words, the terms of the lease-to-own contract are part of the applicant's credit repair plan.

In another embodiment of this Program, even persons who can qualify for conventional financing may choose to participate. For example, a family moving to a new area may choose to participate in the Program because it permits them to live in a neighborhood without committing to the purchase of a home in that neighborhood. If they determine the neighborhood is not what they want, they may choose not to exercise their option. If they do like the neighborhood, they may exercise their option and purchase the home and their rental payments are not completely wasted.

The franchisor provides training and on-going support for the franchisees. For example, the franchisor initially determines if prospective persons or entities qualify to be a franchisee based upon predetermined qualifications, such as net worth, liquidity of assets, credit profile, relative work experience in the industry and knowledge of real estate investment. The prospective franchisees pay a franchise fee and the franchisor then trains the individual franchisees on the operation of the Program and the fundamentals of being a successful franchisee, including how to negotiate real estate contracts, how to buy and sell homes, how to work with lenders, real estate agents, builders, underwriters and other entities involved in assisting prospective home buyers to complete a purchase transaction, how to qualify prospective sub prime home buyers for conventional financing, credit assessments, credit repair plans, principles of underwriting and loan qualification and administration of home owner education programs. The franchisor also provides marketing training. In the preferred embodiment, the franchisor may also operate a website for nationwide or worldwide advertising purposes, for access by third parties such as real estate agents and lenders for information purposes, and as a direct link or portal for franchisees to obtain on-going support and assistance. For example, the franchisor may provide access to form documents, including applications for prospective home buyers, credit applications, leases, closing documents, title documents, and all other documents associated with the types of transactions involved in the present Program. The franchisor may also provide additional information as will be readily recognized by those skilled in the art upon reading this disclosure, including periodic newsletters, seminars and other helpful information for the franchisees. Such information can be disseminated electronically, such as by e-mail or via a web site, by regular mail or by telephone.

In one embodiment, the franchisee also pays fees to the franchisor for each contract the franchisee enters with a prospective home buyer. These fees support the franchisor maintaining national advertising, and support maintenance of the support system by the franchisor.

The franchisee interfaces with the prospective home buyer. A single franchisee may work with one or more prospective home buyers/lessees at any given time. The franchisee purchases the home selected by the prospective home buyer and leases it to the prospective home buyer. In one embodiment of the invention, fulfilling the terms of the lease improves the prospective home buyer's credit rating, and assists the prospective home buyer to qualify for conventional financing at the conclusion of the lease term. At the end of the lease term, if the prospective home buyer has successfully satisfied the terms of the contract, the prospective home buyer exercises its option and the home is sold to the prospective home buyer. An important aspect of the Program is that the terms of the contract between the franchisee and prospective home buyer are determined and set before either the franchisee or prospective home buyer makes any commitment. From the perspective of the potential home buyer, he or she knows the terms of the lease and the purchase price they will pay for the home at the end of the lease term before signing the contract. From the perspective of the franchisee, it will have a signed lease agreement with the prospective home buyer before committing to purchase the selected home. It is intended that there be no surprises.

### BRIEF DESCRIPTION OF THE DRAWINGS

FIG. 1 is a flow chart of one embodiment of the present invention.

FIG. 2 is a block diagram showing the general hierarchy of the relationship among the franchisor, franchisees and lessees/prospective home buyers in one embodiment of the present invention.

FIG. 3 is a block diagram depicting the functionality of a portion of one embodiment of an interactive web site maintained by the franchiser and describing features of one embodiment of the present invention.

FIG. 4 is a block diagram depicting the functionality of a further portion of the web site represented in FIG. 3.

### DETAILED DESCRIPTION

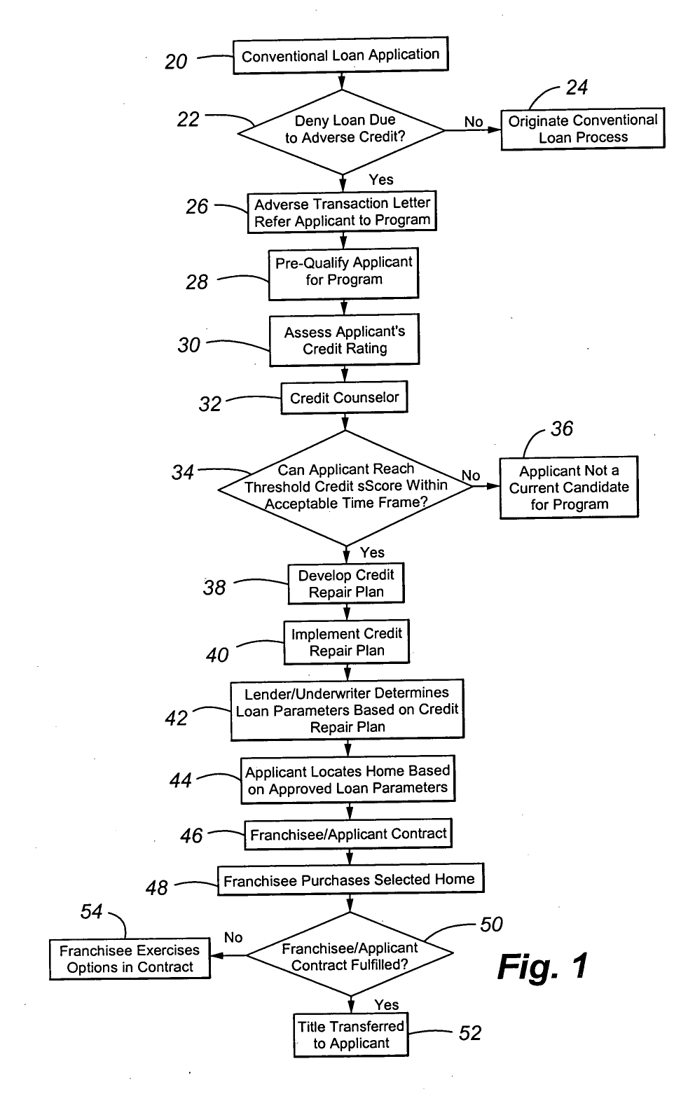

One embodiment of the system of the present invention is depicted by the flow chart shown in FIG. 1. It should be appreciated by those of skill in the art upon review of this disclosure that there are numerous variations to the steps illustrated. In the embodiment of FIG. 1, the process starts at 20, with a prospective home buyer or applicant completing a conventional loan application. The application is processed at step 22. Typically, all lenders and/or underwriters have there own methods of calculating credit scores for applicants. In one embodiment, a FICO credit score is calculated as part of the processing of the application. A FICO score is a credit score developed by Fair Isaac & Co. Credit scoring is a method of determining the likelihood that credit users will pay their bills. A credit score attempts to condense a borrowers credit history into a single number. If the application is approved, meaning that the applicant qualifies for a conventional or government loan, at 24, the process would normally stop, as the applicant does not have a sub prime or negative credit rating. In other words, conventional financing is available to the applicant to purchase a home and the primary benefits of the present invention are not needed. Nonetheless, as explained later, an applicant may still desire to acquire a home using the system of the present invention, due to some of the secondary benefits, despite the fact that the applicant qualifies for conventional financing.

If the application is denied, the denial is communicated to the applicant by the lending institution or underwriter processing the loan application, as is shown at 26. The denial may take the form of a letter or it may be verbal. At this point, the applicant may attempt to pre-qualify for the buyer's assistance Program (the “Program”) defined by the present invention and shown in one embodiment in FIG. 1, as at 28. The lender or underwriter who denied the conventional loan may assist with or perform the pre-qualification or may refer the applicant to a representative or other person involved with the Program, such as the franchiser or franchisees, who can assist the applicant to qualify for the Program. As will be apparent from this disclosure, the conventional lender is motivated to refer the applicant to the Program, as it is the object of the Program to ultimately qualify the applicant for a conventional loan for the purchase of a home, thereby profiting the lender who provides the loan. By assisting an applicant with a sub prime credit rating to qualify for the Program, the applicant will likely use the lender for the conventional loan and the lender will safely expand its loan portfolio.

In one embodiment of the Program, the ability of a prospective home buyer to qualify for the Program may be assessed not only based upon the credit score of the prospective home buyer, but also based upon the prospective home buyer's score from a second credit ranking or matrix. The credit matrix is designed to determine which sub prime applicants will most likely exercise their option and convert a lease to own contract into a home purchase. In one embodiment, the matrix applies eight factors to each applicant. These factors are FICO score, debt ratio, bankruptcy, foreclosure, income, job duration, collections/judgments and charge-offs, and the number of collections/judgments and charge-offs. As shown by the data in Table 1, below, points are awarded to the applicant based upon each category. It should be appreciated that the particular factors applied, the number of factors applied, and the break down of the weighting for each factor can be changed and that the specific factors and weighting identified in Table 1 are not the only manner in which to assess an applicant's likelihood of success. Nonetheless, in the embodiment shown in Table 1 the top score is 60 points. A score of 20 or greater suggests that the applicant is likely to exercise his or her option and convert the lease to own contract into a purchase. A score of 16 to 20 means the applicant maybe subject to additional requirements in order to qualify and a score of less than 16 means the applicant is a poor candidate for the Program.

TABLE 1
FICO Score:

| 660 or higher | 10 points |
|---|---|
| 620-659 | 8 |
| 600-619 | 7 |
| 580-599 | 6 |
| 550-579 | 5 |
| 500-549 | 2 |
| below 500 | 0 |

Debt Ratio:

| | |
|---|---|
| Below 36% | 10 points |
| 36-40% | 8 |
| 41-44% | 6 |
| 45-50% | 3 |
| above 50% | 0 |

Bankruptcy:

| | |
|---|---|
| None | 6 points |
| 3 years old | 5 |
| 2 years old | 4 |
| 1 year old | 3 |
| less than 1 | 0 |

Foreclosure:

| | |
|---|---|
| None | 6 points |
| 3 years old | 5 |
| 2 years old | 4 |
| less than 2 | 0 |

Income (monthly gross):

| | |
|---|---|
| Above $7,500 | 6 points |
| 5,000-7,490 | 4 |
| 3,500-4,999 | 2 |
| under 3,500 | 0 |

Job Duration:

| | |
|---|---|
| Over 5 years | 6 points |
| 2 to 5 years | 4 |
| 1 to 2 years | 3 |
| under 1 year | 1 |

Collections/Judgments/Charge-offs:

| | |
|---|---|
| None | 10 points |
| Under $1,000 | 7 |
| 1,000-1,500 | 6 |
| 1,500-2,000 | 4 |
| 2,000-3,000 | 2 |
| over $3,000 | 0 |

Number of Collections/Judgments/Charge-offs:

| | |
|---|---|
| None | 10 points |
| 1 open | 9 |
| 2-3 open | 7 |
| 4-5 open | 3 |
| over 5 open | 0 |

As shown at 30, the next step in qualifying for the Program is to assess the applicant's credit rating or credit score, including the facts that result in the applicant's unacceptable or sub prime credit rating. This would typically be undertaken by a qualified credit counselor. At 32, the credit counselor, or similarly qualified person, determines if the applicant can improve his or her credit rating and the likely time period it will take to do so. The objective is to improve the applicant's credit rating to the point it is no longer sub prime, but is prime or, at a minimum, so that the applicant qualifies for a conventional loan. Thus, in one embodiment at 34, using an industry accepted scoring system, such as the FICO credit score, the credit counselor determines if the applicant can increase his or her credit score above a predetermined threshold, such as 620. A score of 620 would qualify the applicant to receive a conventional loan from most conventional lending institutions. In addition to improving the applicant's credit rating, the time frame needed for the applicant to improve his or her credit rating is also relevant. As noted previously, the applicant and a franchisee will ultimately enter into a lease-to-own contract. The contract will need to specify the length of the lease period. In the preferred embodiment, the applicant will be able to improve his or her credit rating above the desired threshold value in a period of twelve to eighteen months or less. Of course, this is dependent upon applicant's present credit rating job status, stability and other factors.

If the applicant cannot improve his or her credit rating to an acceptable threshold value within an acceptable time frame, as illustrated at 36, the applicant is not, at this time, a viable candidate for the Program. Should the applicant's circumstances change, the applicant can always start the process anew and apply for another loan or undergo a personal credit analysis and credit counseling.

If the applicant can improve his or her credit score to a predetermined threshold level or better, the credit counselor, working with the applicant, will develop a specific credit repair plan, such as at 38. As part of this process, the applicant will contact his or her creditors and negotiate repayment schedules to the satisfaction of both the creditor and himself or herself. In one embodiment, the franchisee and/or credit counselor will assist and educate the applicant with respect to negotiating an acceptable repayment schedule with the creditors. With the assistance of a franchisee and/or the credit counselor, the applicant will also obtain signed documentation from each of his or her creditors that establishes the negotiated repayment plan is accepted by each of the creditors. In addition, the franchisee may optionally be provided with copies of the credit repair plan and be in communication with the applicant and credit counselor in order to monitor the applicant's progress in successfully implementing the credit repair plan. As addressed in more detail below, the franchisee is preferably trained and equipped to deal with all phases of the Program in order to facilitate and support the entire process to a successful conclusion for everyone involved. Moreover, the franchisor is equipped and staffed to support each of the franchisees in their efforts to successfully implement the Program.

As another option in this process, the applicant may be required to attend homebuyer education class. Homeowner education classes or programs are provided by the franchisees to prospective homeowners to educate the prospective homeowners. These include education on how credit scoring works, including FICO credit scoring, the principles of equity, including how to build equity in a home, the impact of good credit and bad credit on credit ratings, including the effect of late payments, bankruptcy, foreclosures and debt on credit ratings, and other subjects related to understanding credit and home ownership. The franchisor provides training to the franchisees on how to administer these educational programs to the prospective homeowners.

One of the next steps in the process is implementation of the credit repair plan, as shown at 40. As previously noted, one of the steps of implementation is acceptance of the credit repair plan by the applicant's creditors. Unless the applicant's creditors approve the credit repair plan, including possibly rescheduling the applicant's debt payments with respect to the creditors, successful implementation of the plan could be thwarted by one or more disgruntled creditors. Therefore, it is preferred that all creditors approve the aspect of the credit repair plan involving them, and it is equally important that the applicant obtain a written approval from each creditor.

Another step, at 42 in FIG. 1, is determination of a maximum loan amount for the applicant based upon the assumption that the applicant will successfully complete the credit repair plan. Typically, the lender or its underwriter will assess the applicant's background and the credit repair plan and make this determination. In an alternative embodiment, this service may be provided by the franchisor or franchisee. Armed with this maximum amount, at 44 the applicant can begin the selection process for a home of his or her choosing.

At or about this same time, the franchisee and applicant are communicating with each other regarding their prospective relationship, including the terms of a contract that they will ultimately enter with each other. The franchisee explains to the applicant, among other things, the workings of the Program and the various payment or financial options available to the applicant under the Program. For example, in one aspect of the Program, a percentage of the payments made by the applicant will be applied to the purchase price of the home as all or part of the down payment. In one embodiment, a variety of payment option packages are available for the applicant to choose from. This is all explained to the applicant, prior to execution of any binding agreement. Alternatively, the lender who denied the applicant's conventional loan request may also explain the Program to the applicant because of the lender's familiarity with the Program from past experience or from marketing efforts of the franchisor or one or more franchisees. The lender may also refer the applicant to a franchisee.

At 44, the applicant locates a home to purchase. The applicant is only limited by the maximum available loan amount determined by the underwriter, as addressed at 42. There is no geographic restriction; there is no other restriction other than the prospective buyer's own preferences and biases. Indeed, one of the benefits of the present Program is that the applicant may select a home from all homes for sale in a desired neighborhood, just like any other prospective home buyer who would qualify for conventional loan financing. The Program of the present invention applies to new construction and existing homes.

New home construction is treated no differently than existing homes being resold. New home builders will readily realize that the Program can also benefit their business. As previously mentioned, it is believed that there are tens of millions of families that currently wish to purchase a home but cannot do so. The Program of the present invention provides that opportunity to many of those families. Instead of selling a new home to the prospective buyer, the home builder sells the home to the franchisee. There is no downside to the home builder. The home builder is fully paid when the franchisee purchases the home. There are no delayed payments or exceptions. From the perspective of the builder, the sale is a conventional sale.

Once the applicant has selected a home that is within the approval limits of the credit repair plan and maximum loan value, at least two things occur. At 46, the applicant and franchisee enter into a contract, although the contract may be substantially completed prior the applicant selecting a home to purchase. The contract, in general terms, is a lease to own contract. In the preferred embodiment, the applicant will select one of multiple payment options available to him or her. The applicant will also pay a non-refundable option fee to the franchisee. In the example set forth in Table 1 below, the option fee is 3% of the initial purchase price paid by the franchisee, or $4,500.00.

Important in this process is that the applicant fully understands what his or her financial requirements are for fulfilling the lease to own contract before the contract is signed and before the home is purchased by the franchisee. The second thing to occur, at 48, is that the franchisee negotiates with the home seller and acquires the property after the contract between the applicant and franchisee is signed. Because the franchisee has a signed contract from the applicant to lease the property for a defined term, typically twelve to eighteen months, the franchisee knows the cash flow from the lease will cover the mortgage payments and is able to proceed with purchasing the selected home.

Set forth in Table 2 are examples of three financial or payment options that might be available to a prospective home buyer by a franchisee. As seen in the fourth row, the purchase price the franchisee pays for the home is the same, $150,000.00 in this example. As illustrated in the third row, Rent Credit to Buyer, the prospective buyer can choose a plan that provides a credit to the buyer at the end of the lease based upon a percentage of rent paid during the lease term. Under Option A, 50% of the rent paid by the applicant is credited to the purchase price of the home at the end of the lease. Under Option B, 30% is credited to the applicant and, under Option C, 10% is credited to the applicant. Thus, in Row 15, Cash Credit on Monthly Lease Payment, under Option A, the applicant receives a credit of $9,000.00, which is 50% of the total of $18,000.00 in lease payments made by the applicant. Under Option B, the applicant receives a 30% credit, or $6,900.00, and under Option C, the applicant receives a 9% credit, or $3,300.00. The credit is given if the applicant exercises its option at the end of the lease period and purchases the home from the franchisee. If the option is not exercised and the applicant does not purchase the home, the applicant does not receive this credit.

One way to facilitate making this credit available to the applicant is to increase the purchase price of the home paid by the applicant to the franchisee over that paid by the franchisee to the seller. The purchase price to be paid by the applicant to the franchisee varies under the three options. At Row 2, under Option A, the purchase price is increased 15%, under Option B the price is increased 12%, and under Option C the purchase price is increased 9%. Row 7 shows the respective purchase price to be paid by the applicant: $172,500.00 under Option A, $168,000.00 under Option B, and $163,500.00 under Option C. As should also be understood by those skilled in the art, the increase in the purchase price also contributes to the profit made by the franchisee in supporting this transaction. In addition, the maximum loan available to the applicant also factors into the selection of the available options. As the difference between the applicant's maximum allowable loan amount and the purchase price paid by the franchisee for the home decreases, the pool of available money to provide a credit back to the applicant also decreases. Thus, in this example, Option C may be the only option available to the applicant/prospective home buyer.

As shown in Row 5, in one embodiment, the monthly lease price is set at 1% of the price paid by the franchisee in purchasing the home, $1,500.00 per month in this example. It is the same under each option. However, it should be appreciated that the monthly lease payment could also be increased or decreased on a case-by-case basis, primarily depending upon the applicant's financial capabilities, the terms of the credit repair plan and the franchisee's desired cash flow. The cash flow could also contribute to the credit ultimately received by the applicant. For example, if the applicant can afford to pay a larger monthly lease payment, more credit may be available to the applicant at the end of the lease term. Again, these terms would all be decided before the contract is entered, and the contract is entered before the franchisee commits to purchase the home.

Rows 6 through 18 generally illustrate the home buyer's payment calculation for these examples. Using Option A, as previously noted, the purchase price to be paid by the applicant is $172,500.00. This amount must be within the maximum loan amount approved under the credit repair plan. Row 7 shows a down payment of 3%, $5,175.00 in this example. The mortgage amount, or the difference between Rows 6 and 7, is shown at Row 8. Rows 9 through 12 show basic components that contribute to the applicant's monthly mortgage payment which, at Row 13 under Option A, is $1,476.22. It should be appreciated that this example is for illustrative purposes, is not intended to identify every cost associated with closing on the home purchase, and is an estimated amount for purposes of this example.

Row 14 shows a refund of $1,500.00, or one month's rent to the applicant. This is a typical security deposit, retained for purposes of repair or maintenance to the home should the applicant decide not to exercise its option and purchase the home at the end of the lease period. The entire amount may be refunded if no repairs are needed. If the applicant follows through and purchases the home, the money is refunded or credited to the applicant as the condition of the home is now the concern of the applicant, not the franchisee. Thus, including the credit identified in Rows 3 and 15, Row 16 shows the applicant receiving a credit of $10,500.00 at the end of a one-year lease period under Option A.

Row 17 calculates the amount the applicant needs to bring to closing, based upon an assumption that 3% will be required by the lender for a down payment and closing costs will be equal to 2% of the purchase price. Thus, under Option A, the applicant would receive $1,978.50 in cash at the closing, under Option B, the applicant would pay $1,399.20, and under Option C, the applicant would pay $4,776.00. Again, the options are available to meet the varying needs of the applicant and, in one embodiment of the present invention, these options are fixed and in another embodiment, these options may be varied by the franchisor and/or franchisee, depending upon the needs of each individual transaction.

TABLE 2

| | | | | |
|---|---|---|---|---|
| 1. | Option | A | B | C |
| 2. | Increase to Purchase Price | 15% | 12% | 9% |
| 3. | Rent Credit to Home Buyer | 50% | 30% | 10% |
| 4. | Franchisee Purchase Price | $150,000.00 | $150,000.00 | $150,000.00 |
| 5. | Monthly Lease Payment @ 1.00% | $1,500.00 | $1,500.00 | $1,500.00 |
| | Payment Calculation for Home Buyer | | | |
| 6. | Purchase Price in One Year 0.00% | $172,500.00 | $168,000.00 | $163,500.00 |
| 7. | Buyers Down Payment @ 3.00% | $5,175.00 | $5,040.00 | $4,905.00 |
| 8. | Buyers Mortgage Amount | $167,325.00 | $162,960.00 | $158,595.00 |
| 9. | 30 yr. Mortgage @ 7.00% | $1,113.22 | $1,084.18 | $1,055.14 |
| 10. | Taxes (Est.) | $144.00 | $140.00 | $137.00 |
| 11. | Insurance (Est.) | $51.00 | $49.00 | $48.00 |
| 12. | Mortgage Insurance | $168.00 | $163.00 | $159.00 |
| 13. | Estimated Monthly Mortgage Payment | $1,476.22 | $1,436.18 | $1,399.14 |
| 14. | Security Deposit (Refund) 100.00% | $1,500.00 | $1,500.00 | $1,500.00 |
| 15. | Cash Credit on Monthly Lease Payment | $9,000.00 | $5,400.00 | $1,800.00 |
| 16. | Total Cash Back to Buyers After One Year | $10,500.00 | $6,900.00 | $3,300.00 |
| 17. | Estimated Amount Buyer Needs to Meet | $(1,978.50) | $1,399.20 | $4,776.90 |
| | (3% Down and 2% Closing Costs) | | | |

All of the contract terms between the franchisee and applicant/prospective home buyer are negotiated and agreed to up front, before the selected home is purchased by the franchisee. Thus, for the benefit of the applicant, the contract unequivocally states the lease terms and the purchase price to be paid by the applicant. In the embodiment shown by Table 2, the applicant will choose one of the options before signing the contract. The applicant will know ahead of time what amount of credit he or she will receive. It is intended that there be no surprises.

All transactions normal to the purchase of a home occur when the franchisee purchases the selected home from the seller. Title reports are prepared, surveys are conducted, inspections are conducted, title issues and physical defects are corrected. A closing occurs and attorneys normally are involved. In addition, any real estate sales agents that are involved are paid their normal commission. Because all of these normal activities occur, real estate agents and attorneys will also see and understand the benefit of the present Program. They will be paid in the normal course, there is no deferral of their payment. Therefore, real estate agents, home sellers, home builders and real estate attorneys will endorse and support the Program of the present invention as it increases the pool of available home buyers and, as a result, increases their respective businesses.

Following closing on the home purchase by the franchisee, the applicant moves into the home he or she has selected and is now renting. The applicant knows that at the end of the lease period, assuming the terms of the contract with the franchisee are fulfilled, he or she will be in a position to obtain conventional financing and purchase the home. Accordingly, the applicant treats the home as his or her own home. They are not simply a tenant. They will care for and, if possible, improve the home to increase its value and their equity.

At the end of the contract or lease period, at 50, it is determined if the applicant has fulfilled all of the terms of the lease contract and if the applicant desires to purchase the home. If yes, at 52, the applicant exercises its option and the home is sold to the applicant at the predetermined price. According to the contract, a percentage of the lease payments made by the applicant are credited to the purchase price. Importantly, by fulfilling the terms of the lease, the applicant will have improved its credit score based upon the credit repair plan. By satisfying the terms of the credit repair plan, including the terms of the contract with the franchisee, the applicant should now qualify for conventional financing. Therefore, a lender will get a new loan on behalf of the applicant, generating a profit for the lender. Ideally, this is the same lender who originally denied a loan to this applicant, but referred the applicant to this Program. At the second closing, where the prospective home buyer purchases the selected home from the franchisee, the involved parties may be slightly different in that a real estate agent will likely not be involved because the sale from the franchisee to the applicant is pre-arranged. Because the franchisee and applicant have already agreed, in advance, to the terms of sale, there is no need to list the home for sale with a real estate agent. The absence of commissions on the second sale can be taken into account in determining and setting the purchase price to be paid by the applicant to the franchisee.

The franchisee also benefits from this transaction. The increase in the purchase price, for example as shown at Row 2 of Table 2, and the non-refundable option fee create a profit for the franchisee. In addition, the monthly lease or rent fee can be set to provide a positive cash flow to the franchisee. If the franchisee is in a financial position to fully pay for the home without borrowing money, the lease payment can be set at a level the franchisee chooses, presumably near, at or above the return available for other investment vehicles available to the franchisee. If the franchisee borrows money to support the transaction, the lease amount would preferably be set at or above the franchisee's costs for the loan, again generating a positive cash flow for the franchisee. In the latter instance, there would be no out-of-pocket money spent by the franchisee. Most, if not all of the closing costs are borne by the seller, including real estate commissions. And, as previously noted, there are likely to be no real estate commissions when the franchisee sells the home to the applicant. Because the sale from the franchisee to the applicant preferably occurs within 12 to 18 months of the purchase of the home by the franchisee, updated surveys and title reports may not be required. The availability of these funds may also be taken into account in establishing the applicant's costs and the franchisee's profits. Thus, after the credit to the applicant, the franchisee profits from the difference in the selling price of the home between the first transaction, where the franchiser acquired the home from the seller, and the second transaction, where the franchisee sold the home to the applicant/prospective home buyer, from the non-refundable option fee paid up front and, perhaps, from the monthly lease payments.

Alternatively, if the applicant has not satisfied the terms of the contract, at 54, other options are implemented. Other options include renegotiating the lease terms permitting the applicant to remain in the home, locating a new lessee to lease the home from the franchisee on a straight rental basis, finding a new lease to own applicant and repeating the process generally shown in FIG. 1, or the franchisee may simply sell the house on the open real estate market. The franchisee will make this decision based upon the market conditions at the time. The up-front option fee should dissuade lessees from skipping out on the lease and, therefore, protect the franchisee from this occurrence.

In the preferred embodiment, there are numerous services and benefits provided by the franchiser. The franchiser may provide nationwide coordinated services for the benefit of the franchisees. The franchiser may maintain a national advertising fund, to which the franchisees contribute, and the franchisor may conduct nationwide advertising for the benefit of all franchisees which facilitates nationwide or worldwide referrals. As part of this effort, the franchiser maintains a uniform marketing approach, including requiring consistent, high quality and licensed use of trademarks. Similarly, the franchisor is in a position to attend and exhibit at major national real estate conventions and may participate in or support franchisees in attending and exhibiting at smaller, localized real estate conferences, and may provide marketing assistance and materials, including print and audio/visual materials to franchises for use in such conferences or for their use as part of their business. The franchisor may host annual conventions and seminars for the franchisees.

The franchiser also provides individualized support to the franchisees. This involves intensive training related to operating a comprehensive, successful and profitable business, administrative and service training, providing a comprehensive operations manual, both in paper and electronically, a complete software package and updates as available for all contracts, forms and accounting documents, and extensive marketing templates, marketing tools and promotional materials. In addition, the franchiser may provide in-house specialists to guide mortgage brokers to hard-to-find money sources, to provide creative financing alternative ideas, to assist in the preparation of an applicant's credit repair plan, and to work with a franchisee's local underwriters and lenders.

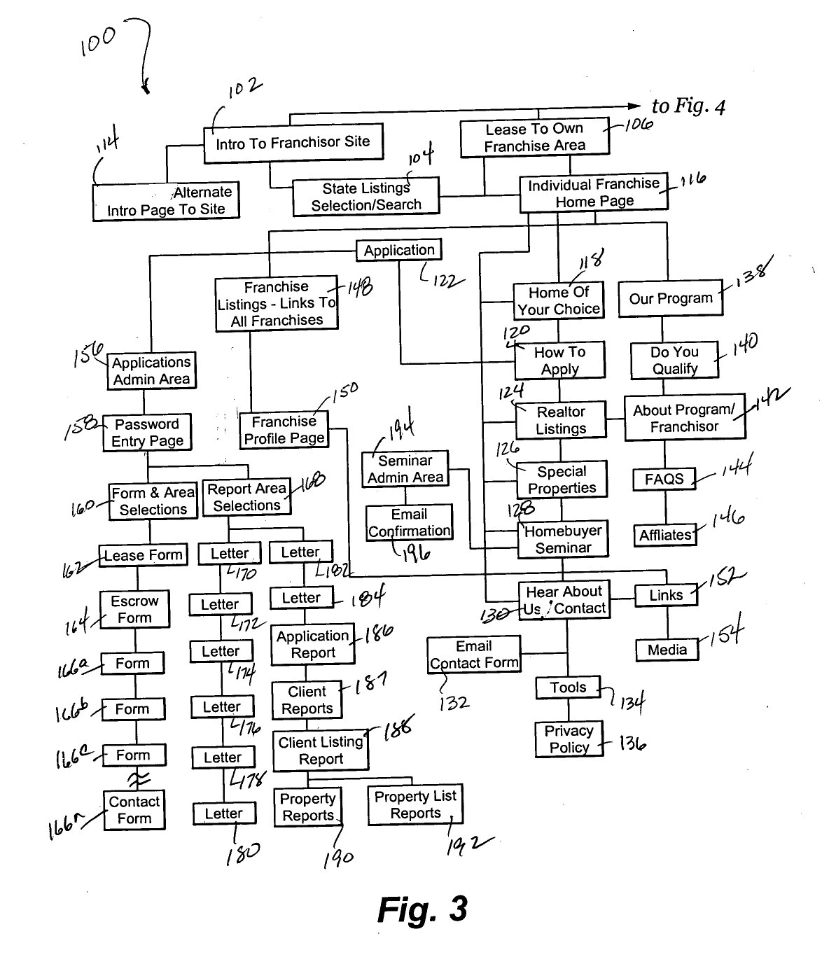

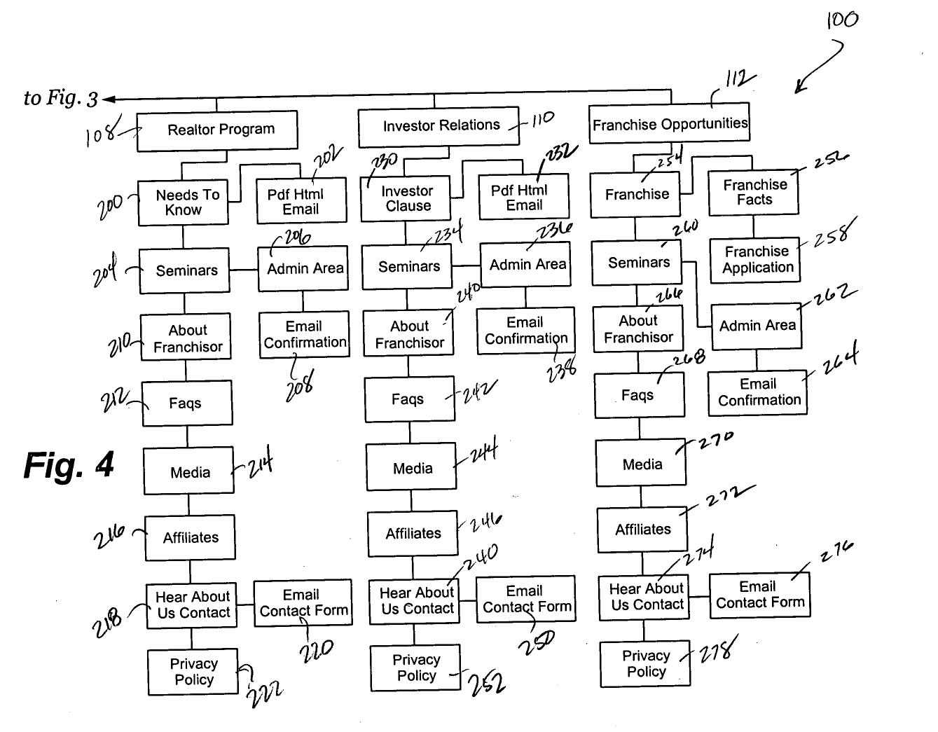

As shown in FIGS. 3 and 4, the franchiser may also provide a sophisticated web site that not only provides access to many, if not all, of the support features identified herein, but also provides helpful information to third parties, such as prospective home buyers, retailers, investors and prospective franchisees. The franchisor may also provide toll-free telephone assistance. The franchisor may also provide guidance on expanding a franchisee's business, discounts from vendors due to volume purchasing, assistance in establishing accounts with suppliers, financial advice and escrow services for rent collection and mortgage disbursements, and warranty services on homes to protect against unforeseen problems.

FIGS. 3 and 4 show a block diagram representative of one embodiment of a franchisor web site 100. Each block is representative of a function of the web site. It should be appreciated that functionalities may be added or subtracted from the web site as would be known to those of skill in the art. At 102 is the introduction page to the web site. From there, at 104, a person may link to a geographic listing of franchisees, such as by state, or a search engine that allows users to locate franchisees in a particular area. From the introduction page 102, a user may also link to a lease-to-own section 106 designed primarily for prospective home buyers, a realtor program section 108 designed for realtors, an investor relations section 110 designed for investors and a franchisee opportunity section 112 designed for prospective franchisees. The web site may also include an alternative introduction page 114 which may be used depending upon the overall organization of the Program. For example, if the Program is structured to include master franchisees and development areas, an alternative introduction page may be used for access by select users.

Turning to the lease-to-own section 106, a prospective home buyer may access web site 106 for a particular franchisee either though a link at the lease-to-own home page 106 or the state listings/search page 104 that facilitates finding a franchisee by geography or other search and filter means known to those of skill in the art. From an individual franchisee home page 116, a user may access a page 118 describing how the Program allows an applicant to qualify to purchase a home of their choice. The user may also access a page 120 that explains how to apply for the Program, which leads directly through a link to a page accessing an application, such as at 122. The user may also link to a listing of homes available for sale by realtors in a franchisee's geographic area, such as at 124. There may also be a link to a page describing special properties, such as at 126. A special property may be a property owned by a franchisee where the applicant chose not to exercise its option. A special property may also be a property that a local realtor is trying to move quickly with the assistance of the franchisee. The user may also access a page of helpful information concerning home buying or advertising seminars on topics related to home buying, such as at 128. There may also be a link to a page asking for feedback from the user, such as at 130, asking how the user learned of the franchisee or the Program. There may also be a link to a page permitting the user to e-mail the franchisee or franchisor, such as at 132. There may also be links to tools, at 134, and a privacy policy, at 136. Useful tools for prospective home buyers include, but are not limited to, a mortgage calculator and a calculator for comparing rent payments versus mortgage payments. Useful tools for franchisees may include access to prediction software that will run various modeling programs. Such programs may calculate the results of hypothetical scenarios relating to lease terms and credit repair plans, allowing the franchisee to change various terms and determine how variable scenarios may play out. The tools page may also allow franchisees to access and order marketing merchandise, such as cups, pens, pins and other items to give away as gifts, and business merchandise such as stationary, business cards, signage and brochures. From the individual franchisee home page 116, a user may also access a page 138 that describes the franchisee's Program, a page 140 that addresses whether or not the user qualifies for the Program, a page 142 that addresses the overall Program and the franchisor, a page 144 that addresses frequently asked questions, and a page 146 that identifies affiliates, such as credit counselors, lenders, real estate attorneys, appraisers, warranty companies and home inspectors. Other links may be to third party websites that provide useful general information, such as information about franchises in general or other information likely to be of interest to potential franchisees or potential applicants/prospective home buyers.

From the individual franchisee home page 116, a user may also access a listing of all franchisees 148, preferably containing links to each franchisee's home page. From the franchisee listing page 148, the user may access page 150 that profiles the various franchisees, and from there to a related links page 152 and a link to media describing the Program overall or particular marketing pieces of individual franchisees at 154.

The web page 100 of the franchisor may also have a portal to a private section just for existing franchisees. In the embodiment of FIG. 3, it is accessed through link 156, which is reserved for administrative matters, such as is related to processing applications by prospective applicants and/or prospective franchisees. To access the secure area a password is required at 158. If the entered password is valid, the franchisee can access a number of areas that provide franchisee support. These include an area 160 containing numerous document forms and templates 162, such as a lease form, an escrow form 164 and numerous other related forms appurtenant to the franchisees' business 166a through 166n.

The secure section may also include a report area 168. The report area may give the franchisees access to various letters needed in running their business and in reporting back to the franchisor. These are accessed at 170 through 184. Access may also be had to various reports at 186 through 192, including application reports, client reports and property reports. In one embodiment, the rent collection from all of a franchisees leases may be handled by an escrow agent. The escrow agent may be a single entity that provides escrow and rent collection services for all franchisees, or these services may be provided by the franchisor. In any event, the franchisee can access up to date reports regarding the status of his or her various properties, including rents paid, timeliness of rent payments, credit accumulated by prospective home buyers/lessees, delinquent accounts, and anticipated conversion dates for the lessee to exercise its option and purchase a home.

If there is an interest in home buyer seminars at 128, a page 194 can be created to administer such a seminar and a related page providing e-mail confirmation of inquiries made by interested persons.

Turning to FIG. 4, one embodiment of specialized web site sections for realtor programs 108, investor relations 110 and franchise opportunities 112 are shown. With respect to the realtor programs section 108, it is contemplated that the web site would include a page 200 conveying information a realtor needs to know about the Program. The pdf, html, email page 202 allows the user to select the format of any information they chose to download. There may also be a page 204 identifying seminars available for realtors to learn more about the Program and a related page 206 for administering the seminars. The franchiser can respond to any inquiries or reservations from realtors at 208.

The realtor program section 108 may also include a page 210 describing the franchisor and the overall Program in a context related to realtors and their business. There may be a frequently asked questions page 212, a page of media, press releases and advertisements related to realtors, such as at 214. There may also be a link to a page about affiliates, including for example real estate attorneys who perform real estate closings, such as at 216. And there may be links to pages inquiring as to how the realtors learned of the Program, such as at 218, a page permitting the realtor or other user to forward an e-mail to the franchisor, such as at 220, and a link to a privacy policy, such as at 222.

The investor relations section 110 has links to pages very similar in concept to the pages in the realtor program section 108. In one embodiment, the franchisor is a corporation with stockholders who will expect a return on their investment. Investors may seek to invest in the franchisor, whether or not the franchiser is publicly traded or a private company. In this regard, it may be useful to have a page 230 addressing the investor clause which identifies the qualifications of an investor and the restrictions and/or limitations that may be placed on the investor's equity interest. Again, at 232 the website would allow the user to select the format of any information downloaded, such as pdf, html or email. The investors may also participate in seminars which address the Program and related topics. Announcements for upcoming seminars are disclosed at 234, together with an administration page at 236 for coordinating the seminars, reservations, attendance and other related matters. At 238, an e-mail can be returned by the franchiser confirming a participant's attendance at a seminar. There may also be links to pages describing the franchisor, such as at 240, links to a page of frequently asked questions, such as at 242, media and other press relevant to the applicant, such as at 244, a link to affiliates, such as at 246, and pages 248, 250 and 252 seeking information about the user, and providing the ability for the user to provide feedback to the franchisor, together with a privacy policy statement, at 252.

Another potential section for the web site is a section on franchise opportunities, such as at 112. As would be appreciated, there may be pages 254 and 256 addressing franchise information and facts, together with franchise application documents at 258. There may also be pages, such as 260 and 262, identifying upcoming seminars regarding becoming a franchisee and providing an administrative area for coordinating seminars, attendance and information concerning related topics. The web site may also include functionality, such as at 264, permitting the franchisor to confirm a participant's attendance or reservation. There may also be a link to a page discussing the franchisor, such as at 266, a link to a page addressing frequently asked questions, such as at 268, a page containing press releases and other media about the Program, franchisees and related topics, such as at 270, a page containing information about affiliates, such as at 272, pages seeking feedback from the user, such as at 274, a page permitting the user to contact the franchisor, such as by submitting an e-mail at 276, and access to the franchisor's privacy policy, such as at 278. Affiliates, as explained earlier, are third party vendors who may provide helpful services to franchisees and others involved in the Program. They may include preferred vendors who have agreed to provide services at a discounted price.

The Program contemplates a single franchisor 300. However, depending upon the geographic extent of the Program, there is likely no practical limitation on the number of franchisees 302. Multiple franchisees can co-exist in the same geographic area, just like conventional real estate agents. Thus, in one embodiment, the franchisor will not grant an exclusive territory to any franchisee, although the franchisor may do so in other embodiments.

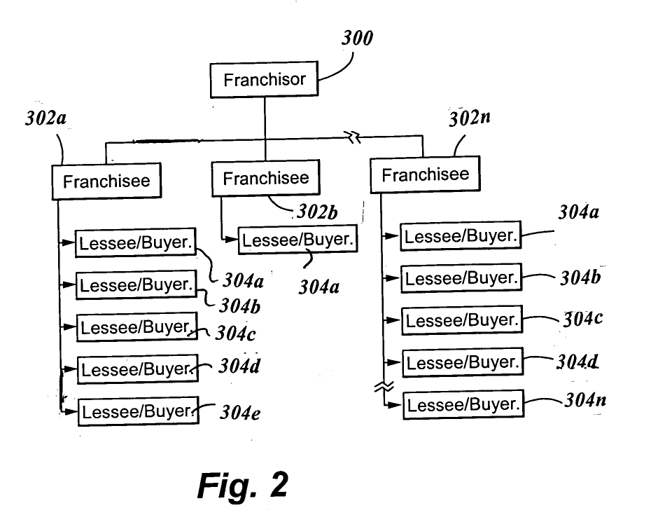

As also illustrated in FIG. 2, each franchisee may choose to simultaneously work with one or more prospective home buyers, based primarily upon the franchisee's financial abilities to carry ownership and financing of multiple properties, as well as the franchisee's ability to manage multiple properties. Thus, there may be an unlimited number “n” of franchisees 302. In this example, in the case of franchise 302a, there are five lessee/buyers currently under contract with franchisee 302a. In the case of franchisee 302b, there is only one lessee/buyer 304a under contract, and in the case of franchisee 302n, there are multiple lessees/buyers 304n working with the franchisee.

In one embodiment, the franchisee profits through receipt of an up-front, non-refundable option fee collected from the prospective home buyer. In one embodiment, this is three percent of the purchase price of the home paid by the franchisee to the seller. In the example of Table 2, the option fee is $4,500.00. The franchisee also receives a portion of the identified increase in the cost of the home, for example, as shown in Row 2 of Table 2. In the example of Option A, the price of the home is increased 15% from the price paid by the franchisee to the seller. In this example, that is $22,500.00. At the successful conclusion of the lease, the prospective homeowner receives a credit of 50% of the lease payments, or $9,000.00. The difference of $13,500.00 is available to the franchisee as revenue. However, the franchisee, as noted previously with respect to one embodiment, pays the franchisor an initial franchisee fee, a transaction fee for each successful option exercised by a lessee, an annual advertising fee, and perhaps other fees. Also, the franchisee further receives monthly cash flow based upon rent collected from the lessee. Preferably, the amount of monthly payments exceeds the franchisee's monthly mortgage payment. It should be appreciated that the type and amount of the fees paid by the franchisee to the franchisor may vary. Flexibility may be necessary for the Program to meet changing market conditions.

Overall, the Program in its various embodiments provides a real estate investor or franchisee the ability to purchase property with a guaranteed pre-qualified lease option tenant. The prospective home buyers or optionees are committed to home ownership, as they have chosen the home and neighborhood with their own needs in mind. They are emotionally committed to the property, because the property will be their future home. Therefore, they are low-risk tenants. Moreover, they are a guaranteed tenant based upon the contract signed by the prospective homeowner prior to the franchisee purchasing the home. As a result, property management issues on the part of the franchisee are significantly reduced because the lease-to-own tenant is committed to maintaining and improving the property.

A primary benefit provided by the Program in its various embodiments is that it makes home ownership available to potentially millions of prospective buyers who presently do not qualify for conventional loans. A second significant benefit is that the Program drastically increases the number of homes available to the prospective home buyer to choose from. Obstacles such as bad credit, foreclosure, bankruptcy, divorce and self-employment which can preclude conventional financing can be overcome by the Program of the present invention. The monthly rent paid by the lessee is, in one context, a forced savings plan, with a predetermined agreed-upon amount to be credited to the lessee upon successful completion of the lease. The prospective home buyer may also select a home needing improvements. Thus, by performing repairs themselves, the lessee may gain sweat equity and rapidly improve the value of the home.

Home builders will benefit from the increased pool of available buyers created by the Program. It can be a marketing advantage in a competitive situation. Even though the franchisee initially purchases the home, the prospective buyer can select all exterior and interior finishes. The franchisee and franchisor, with assistance of qualified professionals, will handle qualifying the prospective buyer under the Program, saving the builder substantial time and effort.

Realtors will also benefit. It is anticipated, in large part due to the franchise nature of the preferred embodiment, that the franchisor and its franchisees will become the largest buyer of single family homes. Realtors will further benefit because homes will be bought and sold and closings will occur even though the ultimate owner, the applicant/lessee, fails to qualify for a conventional mortgage. The initial home seller and realtors are fully paid at the closing where the franchisee purchases the home from the seller. As an alternative embodiment, the franchisor and/or franchisees can also pay referral fees to real estate agents and others for referring qualifying applicants to the Program.

With respect to conventional lenders, the Program allows sub prime-rated applicants to improve their credit rating and, in a relatively short time, qualify for conventional financing from a conventional lender. Given that the potential pool of needy applicants is in the millions of people, lending institutions will see a marked increase in their business and profits.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all of the features of the disclosed embodiments. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A program for acquiring home ownership, comprising:
a. performing a credit assessment of a prospective home buyer;
b. determining if the prospective home buyer qualifies for the program based upon predetermined criteria;
c. selecting a home for purchase from homes available for sale in a target geographic area and within a target price range;
d. entering into a contract with a third party, said contract identifying the terms by which the prospective home buyer can purchase the selected home;
e. having the third party acquire the selected home;
f. fulfilling the terms of said contract;
g. acquiring conventional financing for the prospective home buyer; and
h. transferring ownership of the selected home from the third party to the prospective home buyer.

2. The program of claim 1, wherein the prospective home buyer has a sub prime credit rating based upon the credit assessment.

3. The program of claim 1, wherein the prospective home buyer does not qualify for conventional home purchase financing.

4. The program of claim 1, wherein the target price range is determined based at least in part upon the credit assessment.

5. The program of claim 3, wherein conventional home purchase financing comprises a bank loan, FHA financing and VA financing.

6. The program of claim 1, wherein fulfilling the terms of the contract improves the credit rating of the prospective home buyer.

7. The program of claim 1, wherein the contract includes terms by which the prospective home buyer leases the selected home from the third party for a period of time whereby fulfilling the terms of the lease, the credit rating of the prospective home buyer is improved to the point that the prospective home buyer qualifies for conventional financing.

8. The program of claim 7, further comprising setting the terms of the contract based in part upon the credit assessment.

9. The program of claim 1, further comprising setting the payment terms of the contract to raise the credit rating of the prospective home buyer whereby when the payment terms are fulfilled the prospective home buyer is more likely to qualify for conventional financing in an amount to permit the prospective home buyer to purchase the selected home from the third party at a predetermined price.

10. The program of claim 1, wherein the contract includes the price that the third party will sell the selected home to the prospective home buyer.

11. The program of claim 1, further comprising forming a franchise and, wherein, the third party is a franchisee of the franchise.

12. The program of claim 1, wherein determining if the prospective home buyer qualifies for the program based upon predetermined criteria comprises assessing the prospective home buyer based upon a credit matrix.

13. The program of claim 12, wherein the predetermined criteria comprise at least one of the following: FICO score, debt ratio, bankruptcy, foreclosure, income, job duration, amount of collections, judgments and/or charge-offs, and number of collections, judgment and/or charge-offs.

14. A method for prospective home buyers with a sub prime credit rating and who do not qualify for conventional home loan financing to purchase a home, comprising:
a. performing a credit assessment of the prospective home buyer;
b. determining that the prospective home buyer does not qualify for conventional home loan financing based in part upon the credit assessment;
c. determining a plan to improve the credit rating of the prospective home buyer such that, if the plan is implemented and completed, the prospective home buyer will improve their credit rating;
d. selecting a home to purchase based in part upon the credit assessment and plan;
e. preparing a contract that identifies a price the prospective home owner will pay to acquire the selected home and that includes other terms based upon the plan;
f. having the prospective home owner and a first entity enter the contract;
g. having the first entity purchase the selected home according to the terms of the contract;
h. completing the terms of the contract;
i. obtaining conventional home loan financing for the prospective home buyer for the purchase of the selected home at the agreed price identified in the contract; and
j. transferring ownership of the selected home from the first entity to the prospective home buyer.

15. The method of claim 14, wherein the prospective home buyer leases the selected home from the first entity for a period of time and for a known amount identified in the contract.

16. The method of claim 15, further comprising, at the end of the lease term, crediting the prospective home buyer with a portion of the payments made to the first entity and applying that credit to the purchase of the selected home by the prospective home buyer.

17. The method of claim 15, further comprising returning to the prospective home buyer a portion of the payments made to the first entity at the end of the lease period.

18. The method of claim 17, further comprising applying at least a portion of the returned payments as a down payment by the prospective home buyer in purchasing the selected home from the first entity.

19. The method of claim 15, further comprising obtaining an improved credit rating for the prospective home buyer based, in part, upon the lease payments made by the prospective home buyer to the first entity.

20. The method of claim 14, wherein selecting a home comprises selecting a home from all homes for sale in a desired geographic area having a selling price below a predetermined amount.

21. The method of claim 20, wherein selecting a home comprises selecting a new home.

22. The method of claim 15, wherein preparing a contract comprises allowing the prospective home buyer to select financial terms from multiple options.

23. The method of claim 22, wherein the multiple options comprise different amounts of credit to be applied to the purchase of the selected home for the benefit of the prospective home buyer at the end of the lease period.

24. The method of claim 14, further comprising entering into a contract between the first entity and a second entity.

25. The method of claim 24, wherein the contract between the first entity and the second entity comprises a franchise agreement and the first entity is a franchisee and the second entity is a franchisor.

26. The method of claim 24, wherein the credit assessment of the prospective home buyer is performed by one or both of the first and second entities.

27. The method of claim 24, wherein determining that the prospective home buyer does not qualify for conventional home loan financing based in part upon the credit assessment is performed by one or both of the first and second entities.

28. The method of claim 24, wherein determining a plan to improve the credit rating of the prospective home buyer such that, if the plan is implemented and completed, the prospective home buyer will improve their credit rating is performed by one or both of the first and second entities.

29. The method of claim 24, wherein the second entity provides training to the first entity.

30. The method of claim 29, wherein the training involves one or more of the following areas: assessing credit ratings of prospective home buyers, rehabilitating the credit worthiness of prospective home buyers, buying homes, negotiating with home sellers, and how to obtain conventional loan financing.

31. A system for purchasing homes, comprising:
a. creating a franchise having a franchisor and multiple franchisees, including a first franchisee;
b. having a first prospective home owner and the first franchisee enter a contract;
c. having the first franchisee purchase a home selected by the first prospective home buyer;
d. renting the selected home to the first prospective home buyer according to terms contained in the contract; and
e. selling the selected home to the first prospective home buyer at the end of the rental period which is identified in the contract.

32. The system of claim 31, wherein the first prospective home buyer has a credit rating that does not permit the first prospective home buyer to qualify for conventional home loan financing.

33. The system of claim 32, further comprising improving the credit rating of the first prospective home buyer based upon successful fulfillment of the rental terms contained in the contract.

34. The system of claim 33, further comprising providing the first prospective home buyer with a credit of a portion of the rent payments at the end of the rent period, the credit applied to the purchase of the selected home by the first prospective buyer.

35. The system of claim 31, further comprising operating the franchise on a nationwide basis.

36. The system of claim 34, further comprising allowing the prospective home buyer to select the amount of credit to be received from multiple choices.

37. The system of claim 34, further comprising allowing the prospective home buyer to select a home for purchase from all available homes for sale below a predetermined amount.

38. The system of claim 35, further comprising providing a web site maintained by the franchisor, which web site provides the multiple franchisees with access to form documents for use in connection with operating each franchisee's business.

39. The system of claim 40, further comprising providing on the web site an ability to locate franchisees in a specific geographic location.

40. The system of claim 33, wherein each of said multiple franchisees contracts with a plurality of prospective home buyers.

41. The system of claim 33, wherein every prospective home buyer enters into a contract with a franchisee, further comprising entering the contract prior to purchase of the selected home by the franchisee.
